(19) United States
(12) Patent Application Publication
(10) Pub. No.: US 2008/0121088 A1
(43) Pub. Date: May 29, 2008

(54) ACOUSTICONGA

(75) Inventor: D. Loran Curet Troche, Rochester, NY (US)

Correspondence Address: D. Loran Curet Troche, 7800 A Stenton Avenue #302, Philadelphia, PA, 19118-3007, US

(73) Assignee: Daniel Loran Curet Troche, Rochester, NY (US)

(21) Appl. No.: 11/593,579

(22) Filed: Nov. 7, 2006

(51) Int. Cl. G10D 13/02; G10G 7/02

(52) U.S. Cl. 84/413; 84/454; 84/421; 84/422.1

(57) ABSTRACT

I, D. Loran Curet Troche, invented a new musical instrument named ACOUSTICONGA. This instrument includes a membranophone, a chordophone, an aerophone, and an idiophone, four of the original Sachs-Hornbostel musical instrument classifications. The ELECTROCONGA is the electric version of the ACOUSTICONGA. I propose to introduce a new MECHANICAL VOICE SYSTEM (MVS) into hollow drum shells such as the conga drum which incorporates strings within a hollow drum shell. This MECHANICAL VOICE SYSTEM allows the percussion instrument to produce specific musical notes as typically produced by other string instruments such as the acoustic stand-up bass. Another embodiment of this invention is what I call the SPRING HOUSE, a shock absorption system, which serves to minimize repetitive impact, among other functions. The ACOUSTICONGA also has a MECHANICAL TUNING SYSTEM (MTS) around the drumhead which allows for more accurate and easy tuning of the drumhead as well as the strings.

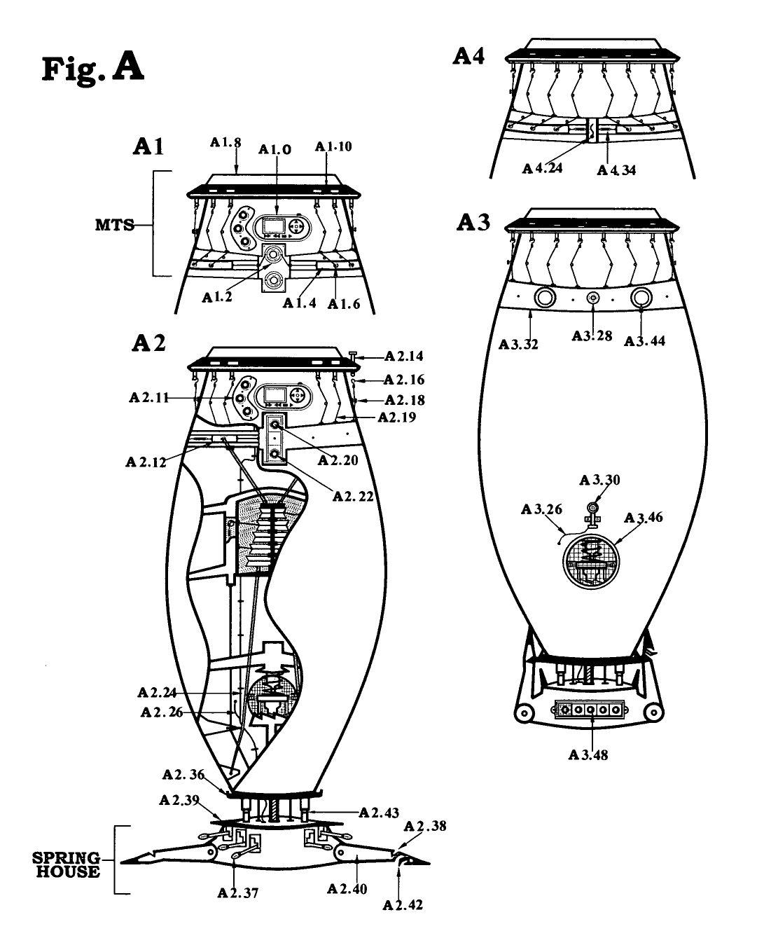

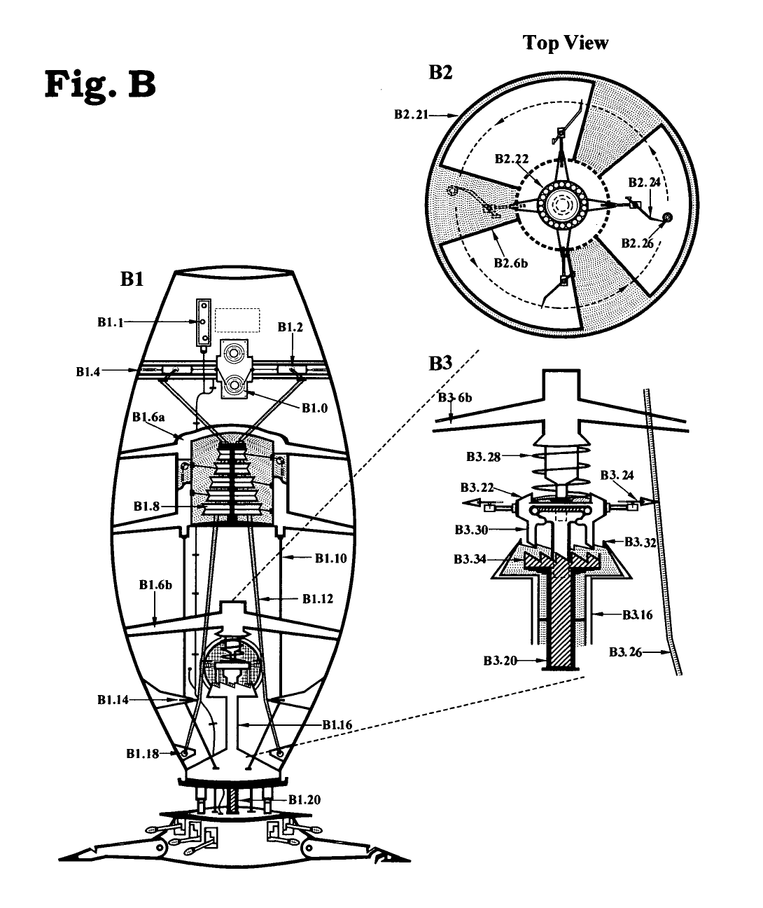

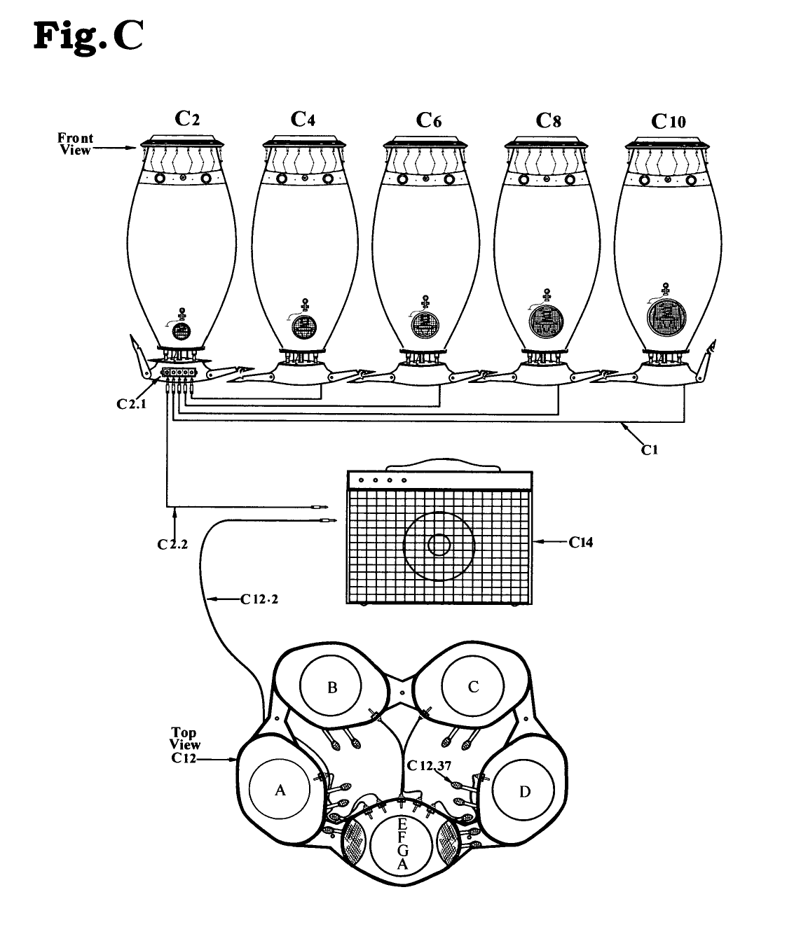

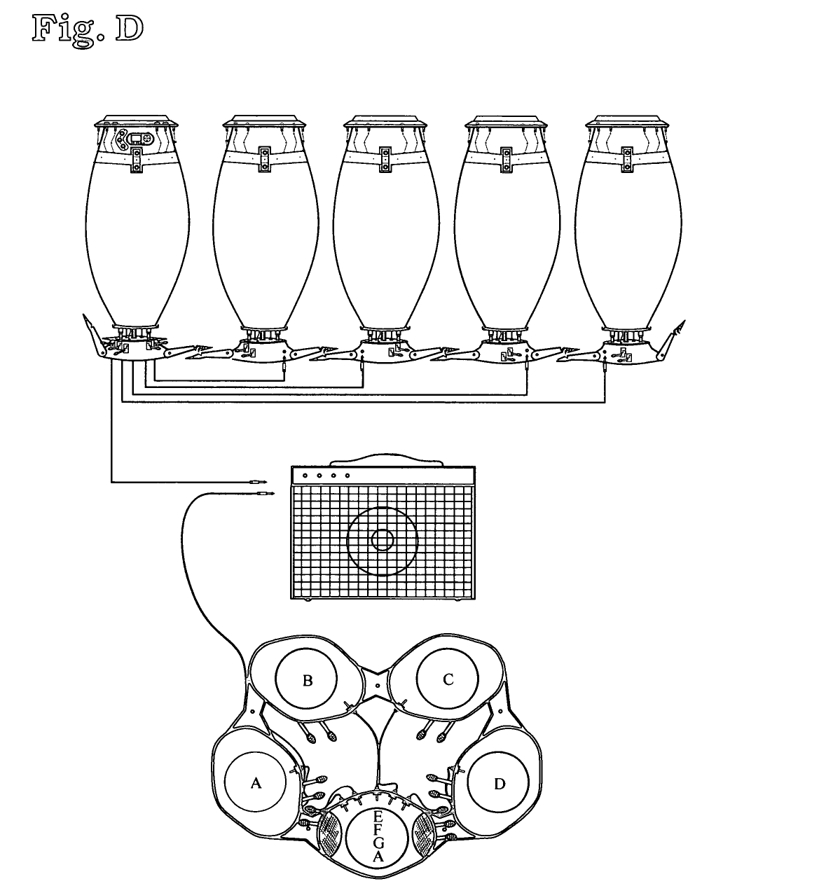

### PRIOR ART

The pedal system in the ACOUSTICONGA for control of the MECHANICAL VOICE SYSTEM of strings has been used for many years since the invention of the harp. The mechanism and use of these pedals for musical tone changes and sound control are described in the “double movement” or “double-action” pedal system in the UK Pat. No. 3332, patented May of 1810, by Sebastian Erard.

U.S. Provisional Patent Application No. 60/736,182, filed Nov. 14, 2005

### BACKGROUND OF INVENTION

The ACOUSTICONGA musical instrument includes a membranophone, a chordophone, an aerophone, and an idiophone, four of the original Sachs-Hornbostel musical instrument classifications. The ELECTROCONGA is the electric version of the ACOUSTICONGA. I will describe and illustrate how the ACOUSTICONGA and ELECTROCONGA work in the following specifications and illustrations. I propose to introduce a new MECHANICAL VOICE SYSTEM (MVS) into hollow drum shells such as the conga drum which will serve to incorporate strings within a hollow drum shell. This MECHANICAL VOICE SYSTEM will allow the percussion instrument to produce specific musical notes as typically produced by other string instruments such as the acoustic stand-up bass. Another embodiment of this invention is what I call the SPRING HOUSE, a shock absorption system, which serves to minimize repetitive impact, among other functions. The ACOUSTICONGA also has a MECHANICAL TUNING SYSTEM (MTS) around the drumhead and upper drum shell portion which allows for more accurate and easy tuning of the drumhead and strings.

### SUMMARY OF INVENTION

The function of having strings within the drum shell includes increased sound wave resonance, thus sound amplification, the possibility of producing digital electric sound, and the ability to produce different musical octaves. The SPRING HOUSE serves to minimize repetitive impact, among other functions. Hand percussionists in particular, may experience hand trauma due to repetitive physical impact while drumming. Bone structure and soft tissue changes typically occur, leading to poor blood and oxygen supply, nerve damage, callus formation and even bone fractures in cases of aggressive inexperienced hand drummers. I propose the use of the SPRING HOUSE for alleviation of this physical impact. Hand percussionists also often play sitting down with drums stabilized in front of them on the ground or floor. The SPRING HOUSE also serves to minimize the repetitive impact between the instrument and the floor. This will diminish wear and tear of the instrument as well as unwanted sounds from impact between the instrument and the ground.

Transport of heavy instruments is also often a challenge to percussionists. I)rum shells of hand percussion instruments such as Congas are often made of heavy wood, metal, or fiberglass, necessary to provide sturdiness and resistance to cracking during percussion. In my ACOUSTICONGA there is a sturdy CENTRAL FRAMEWORK, which can be built from a strong, but light weight material such as carbon fiber, aluminum, or composite materials. The drum shell can also be made of light weight materials including wood. The CENTRAL FRAMEWORK attaches to the SPRING HOUSE, which serves to stabilize the ACOUSTICONGA as a single unit. The use of this CENTRAL FRAMEWORK and SPRING HOUSE allows for the drum shell to be made of light weight materials, including wood, in the construction of this percussion instrument. This CENTRAL FRAMEWORK encompasses the MECHANICAL VOICE SYSTEM previously mentioned. The MECHANICAL TUNING SYSTEM (MTS) is an automatic tuning system which provides more accurate and easy tuning of the drumhead as opposed to the manual tuning method commonly used for percussion instruments with drumheads. This MTS serves to tune the strings of the ACOUSTICONGA as well as the drumhead. These mechanisms all are further demonstrated below.

### DRAWINGS

Legend: Letter#.#=Figure letter, Drawing#. Specific drawing component#

Figure A: MECHANICAL TUNING SYSTEM (MTS) for drumhead and strings, and SPRING HOUSE shock absorption system with pedals for musical note control.
MTS: A1.0—AICLAVE, A1.2—MTS reel, A1.4—Outer sliding plate, A1.6—tuning cable attachment, A1.8, drumhead, A1.10—rim, A2.11—volume, base and treble control, A2.12—inner sliding plate, A2.14—cable anchor, A2.16—cable hook, A2.18—pulley, A2.19—tuning cable, A2.20—Drumhead tuning dial, A2.22—String tuning dial, A2.24 and A4.24—High frequency microphone cable, A2.26 and A3.26—Low frequency microphone cable, A3.28—High frequency microphone, A3.30—Low frequency microphone, A3.32—MTS cover plate, A4.34 MTS spring
SPRING HOUSE: A2.36—closure pin, A2.37—pedal, A2.38—shoe hook, A2.39—foot rest, A2.40—Shoe, A2.42—Shoe pin, A2.43—shock absorbers, Chekere, rattle, or the like—A3.44, Horn formation—A3.46, Plug connector—A3.48

Figure B: MECHANICAL VOICE SYSTEM (MVS) of strings and SNAPPER ACTION mechanism for string vibration.
MVS: B1.0—MVS reel, B1.1—volume, base, and treble control, B1.2—string attachment, B1.4—spring, B1.6a, B1.6b, B2.6b, and B3.6b—central framework, B1.8—scale gears, B1.10—pedal cable, B1.12—musical string, B1.14—bridge, B1.16 and B3.16—central shaft, B1.18—finger pin, B1.20 and B3.20—SPRING HOUSE backbone
Snapper Action Top View and Enlargement: B2.21—outer shell, B2.22 and B3.22—snapper shank, B2.23—Central Framework, B2.24 and B3.24—snapper head, B2.26 and B3.26—musical string, B3.28—snapper spring, B3.30—angular columns, B3.32—jagged edges, B3.34—circular comb

Figure C: Front view, Top View and Amplification system of ACOUSTICONGAS
Front View: C2, C4, C6, C8, C10, Top View: C12, Pedals—C12.37
Amplification System: C1—Cable connectors, C2.1—Central connector, C2.2 and C12.2—Amplifier cable, C14—Amplifier

Figure D: Back view of ACOUSTICONGAS

### INVENTION DESCRIPTION AND OPERATION

This musical instrument is composed of multiple parts including the MECHANICAL VOICE SYSTEM (MVS). The MVS (Figure B) is composed of a CENTRAL FRAMEWORK (B1.6a, B1.6b, B2.6b, B3.6b) which serves as the anchor for the different components of the MVS as well as the SPRING HOUSE (Figure A) and the MECHANICAL TUNING SYSTEM (MTS) (Figure A). The musical strings originate on inner sliding plates (A2.12), components of the MECHANICAL TUNING SYSTEM located toward the end of the shell where the drumhead is placed. The strings then travel centrally away from the outer shell and through the central framework (B1.6a, B1.6b,B3.6b). These strings continue to travel downward, away from the drumhead and outward from the center (B1.12), eventually traveling over a fork on a circular bridge (B1.14). The forks serve to help maintain high levels of tension on the strings for their necessary vibration. After the strings pass over the bridge, they angle outward from the center to attach to a finger pin (B1.18) on the outer shell. A variety of strings including different thicknesses and/or materials may be chosen to be placed around the circumference of the bridge. Different desired pitches and tones may be attained with vibration of the strings upon percussion of the drumhead. For example, each separate MECHANICAL VOICE SYSTEM may be set up to represent a different musical key, allowing each shelled instrument to represent a different musical note (C12). The strings also have an automatic MECHANICAL TUNING SYSTEM (Figure A). The strings travel along the inner sliding plates previously mentioned (A2.12). These strings are pulled for tuning when a tuning dial is manually turned (A2.22). There are two tuning dials associated with the automatic MECHANICAL TUNING SYSTEM, one for tightening the musical strings (A2.22) and another for tightening the drumhead (A2.20). There is a rim (A1.10) that pulls down on the drumhead (A1.8), by pulling down on another metal structure surrounding the drumhead. The rim also has circular openings throughout its circumference for cable anchors (A2.14) to travel through and pull down on the rim. A cable hook with associated pulley (A2.16, A2.18) serves to pull on the cable anchors. The tuning cables (A2.19) travel along the exterior of the drum shell on one set of two outer sliding plates (A1.4) opposite each other. The musical strings travel on the inner sliding plates mentioned previously. Movement of these sliding plates by the turning of the drumhead and string tuning dials subsequently increases or decreases the tension on the attached cables or strings. This said MECHANICAL TUNING SYSTEM is constructed such that movement of the cables, strings and tuning dials can be performed with ease.

The SPRING HOUSE is attached to the drum shell by way of the shock absorber columns (A2.43). The backbone (A2.35, B1.20, B3.20) extends upward from the SPRING HOUSE into the center of the drum shell where the SNAPPER ACTION is located; the mechanism which serves to strike the musical strings causing string vibration. Shock absorbers surround the entire mouth, or closed end if such design desired, opposite the drumhead. These shock absorbers serve to allow downward movement of the drum shell and central framework with every percussion strike of the drumhead. Upon downward movement of the drum shell the snapper head (B2.24 and B3.24) of the SNAPPER ACTION (Figures B2 and B3) which is partially stabilized on the said backbone (B1.20, B3.20), will directly strike the strings (B1.12, B2.26, B3.26) after a series of other sequential movements to be described. Part of the SNAPPER ACTION is free floating and surrounding the backbone. It is weighted and pressured down by springs (B3.28) while being suspended upward in the neutral position by the Jagged-edges (B3.32), a component of the central shaft (B1.16, B3.16). In the neutral position the Jagged-edges suspend the snapper shank (B2.22, B3.22) upward. When the drumhead is hit displacing the drum shell and central framework downward, the jagged-edges are displaced downward as well, leaving the circular comb-edged structure (B3.34) in place to suspend the snapper shank upward by its angular columns (B3.30). The Circular Comb (B3.34) is attached to the backbone (B3.20), both of which are completely stable during drumhead percussion. Therefore, either a Circular Comb-edged structure (B3.34) or surrounding Jagged-Edges (B3.32), depending on which one is in the appropriate position, will push upward on the angular columns (B3.30) of the SNAPPER ACTION. The circle of surrounding Jagged-Edges (B3.32) are attached to the drum shell Central Framework by way of the central shaft (B1.16) and drum shell. The Jagged-Edges surround the Circular Comb (B3.32, B3.34). When the MECHANICAL VOICE SYSTEM and Central Framework move downward with drumhead percussion, so do the attached jagged-edges. Once the Jagged Edges are displaced downward the SNAPPER ACTION drops slightly downward to then be suspended by the Circular Comb, specifically the tip of the Circular Comb teeth. Said teeth push upward on the SNAPPER ACTION angular columns. The angular shape of the SNAPPER ACTION columns cause the columns to slide slightly downward and to the side, off of the tip of the Circular Comb teeth. As soon as the Jagged Edges return back upward to their neutral position, they push the SNAPPER ACTION angular columns back up to their original position. Due to the angular shape of the SNAPPER ACTION columns and the shape of the Jagged Edges, the Snapper shank (B2.22, B3.22) rotates, sliding down the side of the jagged-edges to finalize the full rotation of the SNAPPER ACTION. The full rotation is necessary for the Snapper heads (B2.24, B3.24) to strike the adjacent strings (B2.26, B3.26). These sequential steps all occur almost immediately upon percussion of the drumhead. The applied pressure from the compressed springs above the SNAPPER ACTION allow the rotational motion to occur with enough force to cause vibration of adjacent strings. Each Snapper head also serves to dampen the sound immediately after striking the string by remaining on the string. This prevents over resonance of the string vibration.

At the bottom of the SPRING HOUSE are the base and attached extensions, known as the shoes (A2.40). These shoes, in addition to the base, serve to stabilize the instrument as a whole on the ground or floor. At the tip of the shoes are shoe hooks (A2.38) and shoe pins (A2.42) allowing for multiple shell percussion instruments to be anchored to each other. This serves to add further stability to these shell percussion instruments when standing side by side. The shoe hooks also serve to store away the shoes by folding them upward and hooking onto a closure pin above (A2.36). Attached to the base of this SPRING HOUSE is a minimum of one pedal (A2.37, C12.37) per single unit. These pedals each have a connected cable (B1.10) which travels upward through the CENTRAL FRAMEWORK eventually connecting to the SCALE GEARS (B1.8), which are string pulling devices. These SCALE GEARS of different sizes serve to pull on the strings producing flat, sharp and nature sound tones. The strings travel down and outward away from the drumhead and through openings in the different Circular SCALE GEARS, creating an angular direction of travel. This diagonal direction of travel allows for change in sound volume of the string vibrations when the SNAPPER ACTION strikes the strings. The harder the drumhead is hit the more downward displacement there will be of the drum shell, central framework, and strings. As a result, the closer the Snapper head will get to the strings. The more contact there is between the SNAPPER ACTION and the string, the louder the string vibration will be. There is a SCALE GEAR at different locations along the backbone, one for each pedal. One of the pedals has a different function from the rest. This function is to disable the SNAPPER ACTION and the string sounds, leaving the drumhead and other sounds to be heard alone without the musical strings. Upon pressing one of the other pedals, the SCALE GEARS turn and pull on the strings in one direction such that the tone of the sound produced by the string vibration can be changed to flat, sharp, neutral, A, B, C, D, E, F, G, or on/off, depending on the pedal pressed.

In my particular ACOUSTICONGA shell design, the sound emitted due to drumhead percussion and string vibration travels out of the shell through a horn-like opening (A3.46) on the side of the drum shell. This horn formation will be of a different size, depending on the neutral pitch of the ACOUSTICONGA. The smaller the shell, the higher the ACOUSTICONGA pitch, and the smaller the horn formation will be. The end directly opposite the drumhead is closed allowing the sound to strictly be emitted through the horn formation. In addition, rattles, small bells or the like (A3.44) may be inserted into the side of the drum shell. These areas where the rattles and such insert, have a cover to prevent sound from escaping from the drum shell when these items are not in use. There is also an incorporated slant angle in the construction of the drum shell in order to provide easy hand positioning without the need to tilt the drums. There is at least one high frequency microphone (A3.28) to emphasize the high frequency sounds created by the drumhead and a minimum of one low frequency microphone (A3.30) to emphasize the low frequency sounds from the horn-like opening (A3.46). These sounds are transmitted further by way of cables capable of connecting to an amplifier. Each ACOUSTICONGA has cable connectors (C1). One of the set of ACOUSTICONGAS has the central connector (C2.1) from which the amplifier cable (C2.2) connects to the amplifier (C14). There are also volume, base and treble control knobs (A2.11, B1.1). Last but not least there is a removable digital tuner/MP3 player, AICLAVE, with rhythmic “clave” beats/tempo variations known to the Latin music genre.

The ELECTROCONGA is the electrical version of the ACOUSTICONGA I have previously described. The ELECTROCONGA includes a pick-up for distortion. The pick-up, as is already known, serves to collect sound distortion from vibration; in this case, vibrations of the strings within the shell. The ELECTROCONGA also includes dials for manipulation of sound, including volume and tones.

What is claimed is:

1. A musical instrument comprising of:
a. a cylindrical drum shell with a drum head;
b. a MECHANICAL VOICE SYSTEM comprising of a central framework, strings, stability plate means for string stability and tension maintenance, a bridge means for resonance transfer from strings to outer shell, circular gear means for changing string semi notes, and finger pin means for string attachment to outer shell;
c. an automatic MECHANICAL TUNING SYSTEM mounted to said cylindrical drum shell around said drum head for tightening and loosening said drum head and strings within drum shell; Tightening and loosening said drumhead to provide changes in said drumhead pitch; tightening and loosening said strings within drum shell to provide changes in string tension; said automatic MECHANICAL TUNING SYSTEM comprising of tuning cables, tuning dials, sliding plates, and pulleys for ease of movement of said tuning cables, said sliding plates, and said tuning dial; and,
d. a SPRING HOUSE comprising of a central backbone with SNAPPER ACTION mechanism, shock absorbers, base extensions for stability, and pedals for musical note changes.

2. A MECHANICAL VOICE SYSTEM for use in any musical instrument comprising of an outer drum shell, one or more open ends, one said end of which is covered by a drum head for percussion.

3. An automatic MECHANICAL TUNING SYSTEM mountable on any instrument comprising of an outer drum shell with one or more open ends, one said end of which is covered by a drumhead for percussion.

4. A SPRING HOUSE mountable on any musical instrument comprising of an outer drum shell with one or more open ends, one said end of which is covered by a drum head for percussion.

5. A SNAPPER ACTION mechanism applicable to any musical instrument comprising of an outer drum shell with one or more ends used for percussion with an object or one's hand.

6. The musical instrument as claimed in claim 1, wherein said MECHANICAL VOICE SYSTEM includes an electric pick-up for sound amplification.

7. The musical instrument as claimed in claim 1, wherein said cylindrical drum shell includes one open end covered by a drumhead and another end covered by said SPRING HOUSE; said cylindrical drum shell comprising of a side opening for sound wave emission.

8. The musical instrument as claimed in claim 1, wherein said MECHANICAL VOICE SYSTEM includes a central framework serving as an anchor and encasement for said strings, said stability plates, said bridge, said circular gears, and said SNAPPER ACTION mechanism; said central framework is made of a lightweight material such as carbon fiber or the like.

9. The musical instrument as claimed in claim 1, wherein said MECHANICAL VOICE SYSTEM includes strings traveling from said automatic MECHANICAL TUNING SYSTEM sliding plate on one end, downward away from said end, and inward away from outer shell towards one said MECHANICAL VOICE SYSTEM stability plate; said strings further travel downward and outward away from the center to pass through one or more said stability plates; said strings then travel through said bridge means and angle outward, attaching to finger pin on outer shell.

10. A SNAPPER ACTION as claimed in claim 1, comprising of a circular device with a means for striking said strings; said striking motion also a means for dampening said string vibratory sound.

11. A SNAPPER ACTION as claimed in claim 1, comprising of circular scale gear means for pulling or tightening said strings producing different semitones; said strings angle from inside toward the outer shell creating a diagonal direction of travel through the circular scale gears.

12. The musical instrument as claimed in claim 1, wherein said drumhead includes a letter drawing denoting the open note corresponding to said string or strings set tension in said MECHANICAL VOICE SYSTEM.

13. The musical instrument as claimed in claim 1, wherein said assembly parts including MECHANICAL VOICE SYSTEM, MECHANICAL TUNING SYSTEM, and SPRING HOUSE may be sold as a kit for assembly by consumer or the like.

14. The musical instrument as claimed in claim 1, wherein said instrument may be sold and viewed as a form of art or furniture piece.

15. The MECHANICAL VOICE SYSTEM as claimed in claim 2, comprising of a central framework, strings, stability plate means for said string stability and tension maintenance, a bridge means for resonance transfer from said strings to outer shell, circular scale gear means for changing said string semi notes, and finger pin means for said string attachment to outer shell.

16. Automatic MECHANICAL TUNING SYSTEM as claimed in claim 3, comprising of tuning cables, tuning dials, sliding plates, and pulleys for ease of movement of said tuning cables, said sliding plates, and said tuning dials; said tuning cables, tuning dials, and sliding plate means for tightening and loosening said drum head as well as strings within drum shell.

17. A SPRING HOUSE as claimed in claim 4, comprising of a central backbone with SNAPPER ACTION mechanism, shock absorbers, base extensions for stability, and pedals for musical note changes.

18. A SPRING HOUSE as claimed in claim 4, wherein said assembly parts may be sold as a kit for assembly by consumer or the like.

19. A SNAPPER ACTION as claimed in claim 5, comprised of a circular device with a means for striking musical strings; said striking motion also a means for dampening said string vibratory sound.

20. A SNAPPER ACTION as claimed in claim 5, comprising of circular scale gear means for pulling or tightening musical strings producing different semitones; said strings angle from the inside toward the outer drum shell creating a diagonal direction of travel through the circular scale gears.
